(19) United States
(12) Patent Application Publication
(10) Pub. No.: US 2007/0192490 A1
(43) Pub. Date: Aug. 16, 2007

(54) Content-based filtering of electronic messages

(76) Inventor: Sandip S. Minhas, San Diego, CA (US)

Correspondence Address: QUALCOMM INCORPORATED, 5775 MOREHOUSE DR., SAN DIEGO, CA, 92121, US

(21) Appl. No.: 11/353,268

(22) Filed: Feb. 13, 2006

(51) Int. Cl. G06F 15/173

(52) U.S. Cl. 709/226

(57) ABSTRACT

Described are techniques and mechanisms for filtering electronic messages based on the content of the messages to prevent downloading certain messages to a client. Very generally stated, user-configurable content-based filters are used at the server to control the download of messages to the client. Identifying information about the client may be used to filter messages differently than with other clients.

### BACKGROUND OF THE INVENTION

The invention relates generally to the field of electronic messaging, and more particularly to systems and methods for filtering electronic messages.

Electronic messaging has become commonplace. It is widely available to users in the workplace, at home, and even on mobile devices like cellular phones and personal digital assistants. E-messaging takes very many forms, such as e-mail, instant messaging, Short Messaging Service (SMS) messages, Multimedia Messaging System (MMS) messages, and the like. As used throughout this document, the terms “e-messaging” and “messaging” will be used interchangeably to include any form of electronic communication using messages, regardless of the particular format or structure of messages, or protocols employed. Likewise, the term “message” means an electronic communication in any form and using any protocol, such as e-mail, instant messages, SMS messages, MMS messages, and the like.

Users often check their messages using different hardware. For instance, a user may use a hardwired desktop computer to check messages while in the office, but a wireless mobile device to check messages while out of the office. The different types of hardware usually have different bandwidth capabilities and latency characteristics. For instance, desktop computers today may be connected to a network at gigabit speeds, while wireless devices still commonly have a bandwidth in the kilobit range. Users commonly prefer to retrieve all their messages while using a high-bandwidth device (e.g., desktop computers) but may prefer to retrieve only certain messages on their bandwidth-constrained devices (e.g., wireless mobile devices).

Some rudimentary mechanisms have been implemented to address this concern. More specifically, some electronic messaging programs exist that allow the user to set an option to leave (i.e., not download) messages on the message server that exceed a certain size. This feature is beneficial for devices with limited band-width. Although this works well for size-based decisions, conventional messaging applications do not enable the user to set a similar parameter based on any other factors, such as content.

Today, the number of unsolicited messages (e.g., “junkmail”) received by individuals can be staggering, and is ever increasing. Current messaging applications can filter received messages based on a probability that the content is junkmail, and direct such messages to a special junkmail folder. However, the e-mail is not held at the server, but rather downloaded from the server onto the local device (e.g., desktop computer, wireless mobile device, personal digital assistant, etc.). Thus, undesired messages, such as e-mail viruses, are still downloaded onto the user's device and may cause harm. Similarly, users may receive a high volume of messages based on personal interests or from mailing lists. Messages from interest groups may be desirable in a high-bandwidth environment, but may be undesirable when bandwidth is constrained.

These and other problems continue to exist with the current messaging technology. An adequate solution to these problems has eluded those skilled in the art, until now.

### SUMMARY OF THE INVENTION

The invention is directed to techniques and mechanisms for filtering electronic messages based on the content of the messages to prevent downloading certain messages. In one aspect, the embodiments of the invention enables a computer-implemented method or computer-executable instructions for electronic messaging performed at a server that includes the steps of receiving an electronic message, receiving a request for messages from a client; applying a content-based filter on the electronic message, and if the electronic message does not fail the content-based filter, making the electronic message available for retrieval by the client. The content-based filter is configurable to determine if the electronic message should be retrieved by the client.

In another aspect, embodiments of the invention enables a computer-implemented method or computer-executable instructions for electronic messaging performed at a client, including the steps of issuing a request for new messages to a server, receiving a list of messages at the server that satisfy a server-side content-based filter, the list of messages excluding messages at the server that fail the server-side content-based filter, and retrieving at least one of the messages on the list of messages.

In yet another aspect, embodiments of the invention enables a server for delivering electronic messages that includes a communication module operative to support a communication session between the server and a client that requests to retrieve messages, a storage medium on which is stored at least one electronic message, a processor, and a memory coupled to the processor and the storage medium, and in which re-sides computer-executable components of a messaging system. The components of the messaging system include a message server configured to perform message delivery services, filter criteria that identifies characteristics of electronic messages that have been deemed undesirable for download to the client, and a message filter operative to evaluate the at least one electronic message stored on the storage medium against the filter criteria to identify if the electronic message fails the filter criteria.

In still another aspect, embodiments of the invention enables a client for retrieving electronic messages that includes a communication module operative to support a communication session between the client and a server on which are stored electronic messages, a storage medium, a processor, and a memory coupled to the processor and the storage medium, and in which resides computer-executable components of a messaging client. The messaging client further includes a token including a unique identifier, filter criteria, and a message filter operative to evaluate an abbreviated portion of an electronic message transmitted to the client from the server, the evaluation being per-formed using the filter criteria.

### BRIEF DESCRIPTION OF THE DRAWINGS

The invention will become more apparent from the detailed description set forth below when taken in conjunction with the drawings in which like reference characters identify correspondingly throughout.

FIG. 1 is a functional block diagram generally illustrating a messaging system that includes server-side content-based filtering to eliminate downloading certain undesirable messages to a mobile device.

FIG. 2 is a functional block diagram generally illustrating in greater detail the messaging system portion of the server illustrated in FIG. 1.

FIG. 3 is a functional block diagram generally illustrating in greater detail the mobile device portion of the system illustrated in FIG. 1.

FIG. 4 is an operational flow diagram generally illustrating the flow of information between a server and a client when retrieving messages.

FIG. 5 is an operational flow diagram generally illustrating a process performed at a server for making messages available to a client, in accordance with an embodiment of the invention.

FIG. 6 is an operational flow diagram generally illustrating a process performed at a client for retrieving messages from a server, in accordance with an embodiment of the invention.

FIG. 7 is a functional block diagram generally illustrating the core components of a sample computing device in which implementations of the invention are particularly applicable.

### DETAILED DESCRIPTION

What follows is a detailed description of various mechanisms and techniques to avoid downloading certain messages by using filters. Very generally stated, user-configurable content-based filters are used to control the download of messages. Embodiments of the invention will now be described first with reference to functional diagrams of mechanisms and components that may implement the invention, and next with reference to logical flow diagrams of processes that may implement the invention.

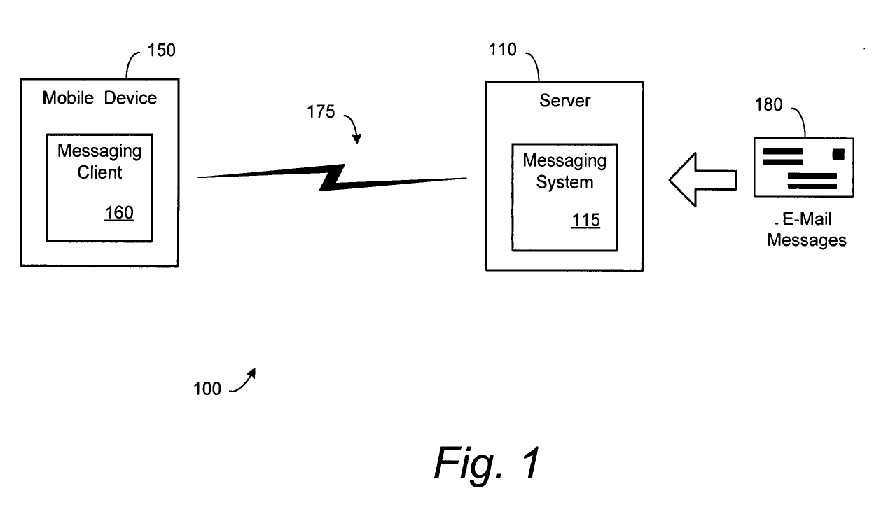

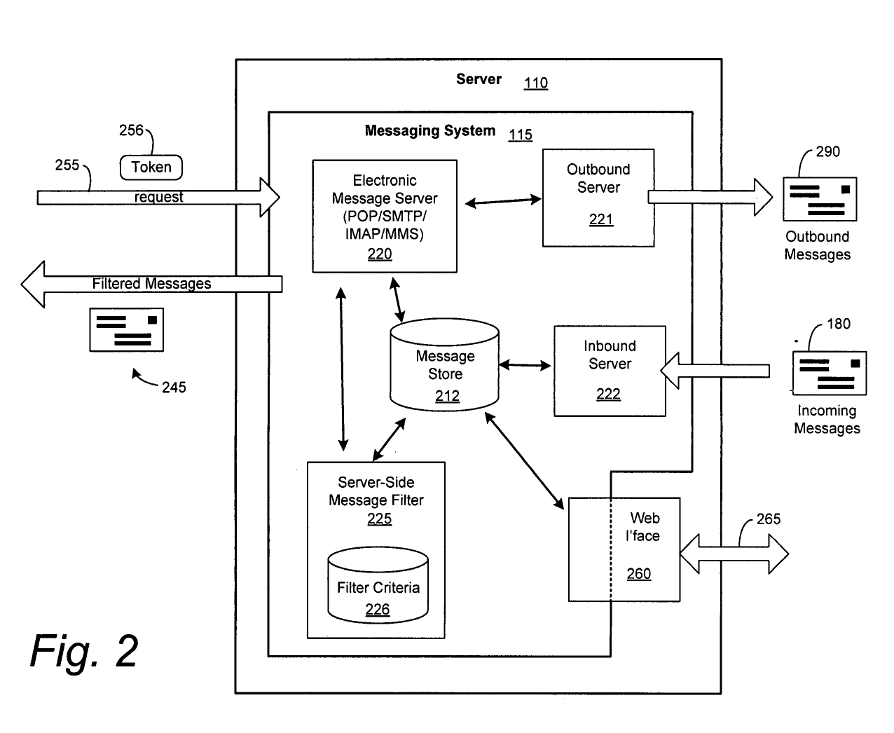

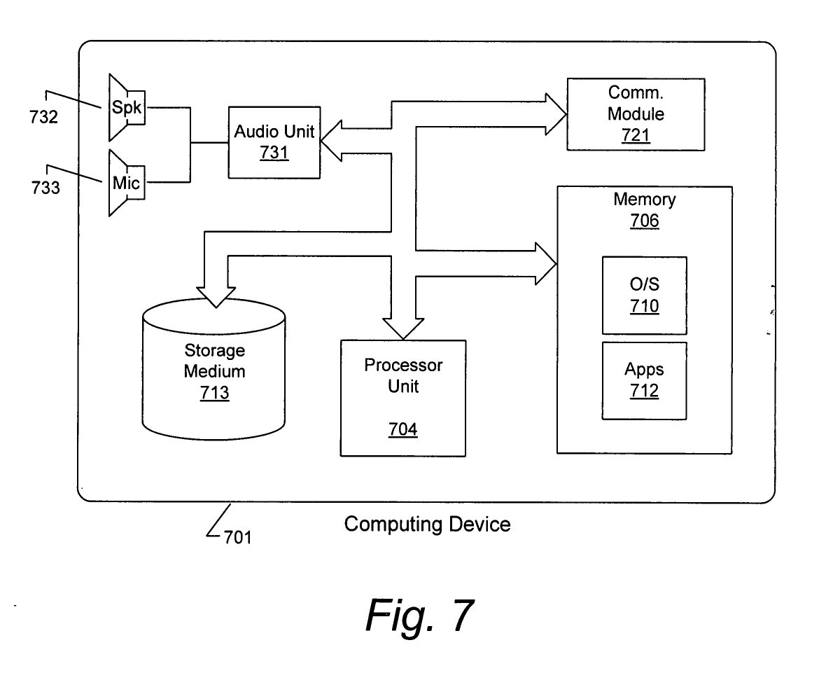

FIG. 1 is a functional block diagram generally illustrating a sample system 100 for communicating messages from a messaging system 115 on a server 110 to a messaging client 160 on a device 150. The system 100 is only one example of how the inventive techniques and mechanisms may be implemented, and should not be considered exclusive of other implementations. As illustrated, the server 110 includes the messaging system 115 and may be any computing device configured to support the receipt of electronic messages 180 from various origins and directed at users of the messaging system 115. The messaging system 115 includes a message filtering system, described in greater detail in conjunction with FIG. 2. Briefly described, the messaging system 115 includes user-customizable filtering mechanisms to determine whether to hold some or all of the incoming messages 180 at the server 110, or to allow some or all the incoming messages to be downloaded to the device 150. FIG. 7 illustrates one sample computing system that may be used in certain implementations of the server 110.

The device 150 could be any device that presents computing functionality and communicates with the server 110 remotely over a communications link 175. Device 150 may be a mobile wireless device, such as a mobile phone or a personal digital assistant (PDA). Device 150 may also be a computer device, such as a laptop computer, operating in a mode that has relatively lower bandwidth, such as over a wire-line connection, or a wireless connection over cellular. Accordingly, devices that benefit most from the techniques and mechanisms described here are typically mobile. Such devices either communicate with the server 110 over a communications link 175 of relatively low bandwidth and/or high latency, or are equipped with relatively limited storage space and/or processing power, or both. FIG. 7 illustrates one sample computing system that may be used in certain implementations of the device 150.

In one particular implementation, the device 150 may be a cellular telephone with messaging capabilities. In this example, the device 150 likely has both limited bandwidth and storage space. In another implementation, the device 150 could be a personal digital assistant or the like with greater storage and processing capacity but the same low bandwidth and/or high latency communications link. In still another implementation, the device 150 could be a stand-alone special purpose device with a greater bandwidth connection but yet may still have storage constraints. In yet another implementation, the device 150 may be some mobile or fixed device that has sufficient bandwidth and storage resources, but a user may simply desire to have message filtering performed at the server 110 to conserve those resources.

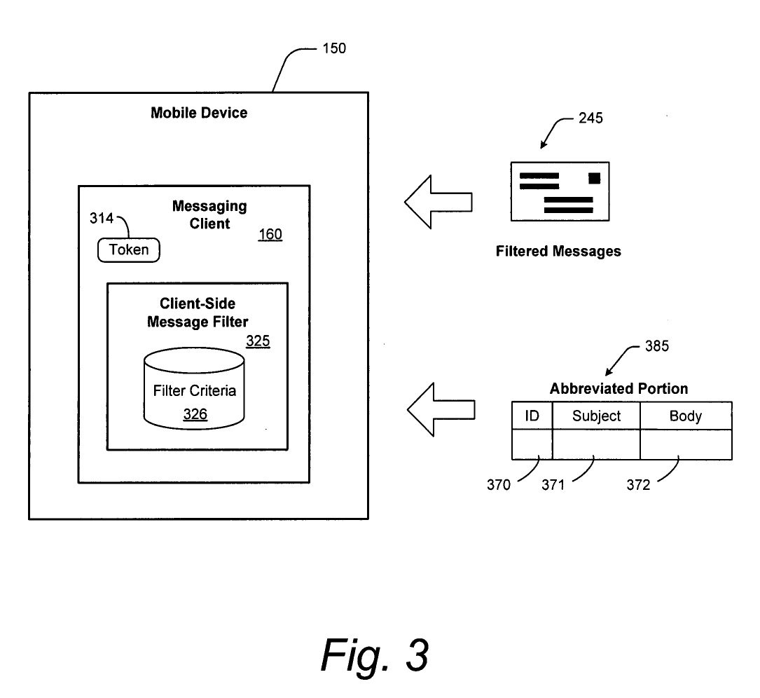

The messaging client 160 is configured to receive or retrieve messages from the server 110. Generally stated, the messaging client 160 interfaces with the messaging system 115 on the server 110 to identify any incoming messages 180 that are desirable for download. The messaging client 160 and the messaging system 115 include improvements, described in detail in conjunction with FIGS. 2 and 3, to support that functionality.

The messaging client 160 may additionally include functionality to perform a client-side message analysis to help determine whether to retrieve or receive messages from the server 110. In one embodiment, the client-side message analysis is performed on a sample portion of a message that is transmitted from the messaging system 115 to the messaging client 160 for the analysis. This feature allows some questionable messages to be further analyzed at the device 150 without retrieving the entire message, thereby conserving some bandwidth.

As mentioned, the two systems communicate over a communications link 175, which is commonly wireless. Alternatively, the communications link 175 may be a low-bandwidth or high-latency land line. Although only the server 110 and the device 150 are illustrated in the figures, it will be appreciated that many other components may be necessary to facilitate the communication link 175 between the server 110 and the device 150, such as radio frequency transmitters and receivers, cellular towers, network gateways, and the like.

The server 110 and the device 150 communicate in accordance with a messaging protocol, such as Post Office Protocol (POP), Simple Message Transfer Protocol (SMTP), Internet Message Access Protocol (IMAP), Multimedia Messaging Service (MMS), Short Messaging Service (SMS), or the like. Alternatively, the two systems may communicate using an instant messaging service, or the like. The device 150 may initiate requests to learn of new messages from the server 110, or the device 150 may be configured to accept asynchronous notifications of new messages from the server 110. In addition, the device 150 and the server 110 may be configured such that the device 150 requests delivery of specific messages it has been notified about, or all messages, or possibly all messages meeting some criteria, such as being new, below a certain size, and so forth.

In operation, the server 110 receives messages 180 intended for the user of the device 150. The device 150 connects to the messaging system 115 to initiate a new messaging session. As part of that session, the device 150 may issue a request for information about messages stored at the server 110. One example of such a request is a UIDL (Unique IDentifier List) request known in the POP protocol. In one improvement, the request may include an identifier parameter (e.g., a “token”) used to distinguish the device 150 from other devices that may be used by the user to retrieve messages.

In response to the request, the messaging system 115 applies any server-side filters that may have been configured by the user. In accordance with the invention, the messaging system 115 on the server 110 includes content-based filtering mechanisms that are configured by the user to determine whether a message should be held at the server 110 or downloaded to the device 150. The determination could be made based on a probability that a message is spam, a subscription to certain mailing lists, a preferential senders list, a keyword or Boolean combinations of keywords, or the like. For example, a user that subscribes to a “bikes” or a “remodeling” mailing list may desire not to receive messages addressed to “bikes.mail” or “remodeling.mail” on a given device, such as a wireless phone or computer using a dial-up modem. Also, the determination may be made in the negative, such that only messages from certain senders or messages that contain certains keywords will be downloaded to the device 150.

In one implementation, the messaging system 115 includes filters that the user has configured to simply tag such messages to be held at the server and retrieved at a later time or perhaps using another retrieval mechanism, such as a Web-based messaging application that provides direct access to the message storage at the server 115. The filters on the server can be configured by the user either from the device 150, using a user interface on that device, or using the Web-based messaging application.

Once the appropriate filters have been applied to the incoming messages 180, those that do not fail the filter criteria are made available to the device 150 for download. In one example, the messaging system 115 may return a listing of messages stored at the server 110 that did not fail the filter criteria. The listing includes a unique identifier for each of the messages, allowing the messaging client 160 to retrieve the messages individually, in various subsets, or as a group.

This system improves over existing technologies by enabling the messaging system user (i.e., the user of the device 150) to make a determination a priori whether to retrieve particular messages based on the content of the message without first downloading the entire message. In addition, this system enables the user to configure multiple devices to retrieve messages using different criteria based on the particular capabilities of the device being used.

FIG. 2 is a functional block diagram generally illustrating in greater detail the messaging system 115 of the server 110 illustrated in FIG. 1. In this implementation, the messaging system 115 includes an inbound server 222 to receive incoming messages 180, and an outbound server 221 to transmit outbound messages 290. The inbound server 222 places incoming messages 180 into a message store 212 where they can be accessed by other components of the messaging system 115. An electronic message server 220, such as a POP/SMTP, IMAP/SMTP, and/or MMS server for example, interacts with a client to make at least some of the incoming messages 180 available to the client, and to receive outbound messages 290 from the client for transmission by the outbound server 221. The message server 220 may communicate with or be integrated into other components of the messaging system 115.

In accordance with the invention, the messaging system 115 also contains a message filter 225 that interacts with the message server 220 and the message store 212, and performs a message analysis on incoming messages 180 using the user-configurable filter criteria 226. The filter criteria 226 can take any number of arbitrary forms. For instance, the message filter 225 could be configured to look for matches to fixed strings anywhere or in specific fields within the message content or protocol, to look for particular situations in specific fields in the message content or protocol (such as long runs of white space in the message subject, a subject or from address which ends in a number, a subject which starts with “Re” in a malformed way (such as lack of colon or space following “Re”), a subject which starts with “Re” in a message which does not contain an “In-Reply-To” header), looking for anomalies in the protocol, and so forth. Similarly, the filter criteria 226 could be configured to identify messages that are from a particular sender or list of senders, if the number of recipients exceeds some identified number, messages that are identified as being “priority” messages, or any other criteria against which the message filter 225 can compare the content of the incoming messages 180 to determine whether the messages should be passed on to the requesting device (i.e., the client).

In one improvement, the message filter 225 is configured to apply different filter criteria 226 depending on which device requests the listing of messages. More particularly, the filter criteria 226 may include different rules that are each associated with one or more different messaging clients. For instance, many users use different devices to retrieve their messages. A user may check his messages from a laptop computer using a dial-up modem, a desktop computer using a high-speed network, and a mobile phone using the low bandwidth cellular service. These devices each have different bandwidth and storage capabilities. Accordingly, the user is likely to have a different level of tolerance concerning which messages to retrieve to each device. Thus, the user could configure different filter criteria 226 to be applied based on which device is being used to retrieve messages. In one implementation, certain filter criteria 226 could be associated with one or more tokens that each correspond to a particular device. In this way, the messaging system 115 can make different sets of messages available to the user based on which device the user is currently using.

The message server 220 interacts with a client to perform message delivery services. As part of those services, the client may issue a request 255 to the message server 220 for new messages stored at the server 110. In one example, the client may issue a UIDL or LAST request to the message server 220, which responds by returning a list of the new messages. In one implementation of the invention, the request 255 includes a token 256 that uniquely identifies the client or computing device on which the client resides. The nature and origin of the token is described more fully in conjunction with FIG. 3 below. Briefly stated, the token is some identifier that uniquely identifies the originator (e.g., client or device) of the request 255. The message filter 225 can use the token 256 from the request 255 to determine which client is requesting new messages, and invoke any device-specific filter criteria 226, thus enabling the user to receive notice of only those messages that are of interest given the particular device currently being used. For example, the filter criteria 226 may include a statement generally to the effect of “if token=“Micky's_phone” then <filter logic>” where the <filter logic> is the particular rule to be applied in the case that a request for messages includes the token “Micky's_phone”. If the request does not include that token, the rule is not applied.

In some cases, rules established by the user may be in conflict. For example, the filter criteria 226 may include one rule to block messages over a certain size, and another rule to always allow messages from a given user. Thus, if the given user is sending a message over the certain size, the rules are in conflict. These conflicts and other issues can be avoided by the implementation of a hierarchical rule structure. In such an implementation, certain rules may be applied even though they are in conflict with other rules. In the example above, for instance, the rule allowing messages from the given user may be given prioritization over the rule limiting message size, thus resolving the conflict.

In some cases, after performing the filter analysis, a message may have an identified score (e.g., a spam score) that indicates the message may possibly be undesirable but is not clearly undesirable. For instance, the score may indicate that a message may possibly be spam but is not highly likely to be spam. In those or similar cases, such as if a message is subject to rule conflict, the messaging system 115 may be configured to return an abbreviated portion of the message (rather than the entire message) to the mobile device for a final decision whether to retrieve the entire message. The portion could be returned with the filtered messages 245 or as a “headers only” transfer. In this way, the client could employ local filtering mechanisms to further determine whether to retrieve the message or not. Alternatively, the portion of the message could be presented to the user for a human determination.

The portion could be all or a selected subset of the message headers (including the message subject header), and may additionally include some, but less than all, of the message body. In one specific implementation, the messaging system 115 creates a new header for the message, such as an “X-” header which is a special header designation used to transmit arbitrary information. The portion of the message could be an abbreviated part of the message body transmitted in the special purpose “X-” header. The amount of the message body transmitted could be based on a user-configurable size, perhaps in bytes or as a percentage of the entire message. In addition, particularly if the message includes markup language tags, the abbreviated portion could include the textual part of the message (or a portion of it) without any tag information. Many other alternatives will become apparent to those skilled in the art.

The server 110 may also include a Web interface 260 that interacts with the messaging system 115 and external systems over a wide area network connection 265 to make functionality on the server 110 publicly accessible. The Web interface 260 allows users to access their messages stored in the message store 212 while connected over the Internet or other wide area networking technology. Using the Web interface 260, the user can connect to the messaging system 115 and examine any messages that were marked as spam and not downloaded to the mobile device. Moreover, the Web interface 260 can be used to create, configure, modify, and remove filter criteria 226.

FIG. 3 is a functional block diagram generally illustrating in greater detail the device 150 shown in FIG. 1. The device 150 may include several applications, including a messaging client 160 and also possibly browsing software (not shown). Although the messaging client 160 could be configured to use any type of messaging protocol, in this particular implementation the messaging client 160 is configured with conventional e-mail client functions, such as receiving and composing e-mail messages, and the like. The messaging client 160 could equally be configured to communicate messages through any other messaging system, such as instant messaging or the like.

The messaging client 160 is configured to retrieve filtered messages 245 by issuing a request for new messages to the message server 220 (FIG. 2). In this particular implementation, the messaging client 160 includes a token 314, which is an identifier used to distinguish the messaging client 160 on the device 150 from other devices or messaging clients. The token 314 could be any type of identifier that can be used to distinguish one particular messaging client from another. For instance, a lengthy (e.g., 128 bit) hexadecimal code could be used as a globally unique identifier. Alternatively, the token 314 could be simply a textual identifier provided by the user of the device 150, such as “Micky's_phone”, “Robert's_laptop”, or “Tami's_desktop.” This textual identifier could be provided by the user through a configuration interface for the messaging client 160 at install time. Different tokens (e.g., “Micky's_desktop”, “Robert's_phone”, or “Tami's_laptop”) could then be configured on any other devices the user uses to check messages. The user could then include the tokens in any device-specific filter criteria 226 (FIG. 2), thus providing the message server with the ability to apply different pre-configured rules based on which device the user is currently checking messages with.

The messaging client 160 may be configured to transmit the token 314 with the request for new messages to the server. In one specific implementation, this operation may involve an extension to certain commands in a messaging protocol, such as the LAST or UIDL commands in the POP e-mail protocol, to support transmitting information in addition to an ordinary user logon and password sequence. Alternatively, the messaging client 160 may be configured to transmit the token 314 while initiating a messaging session, such as during an initial logon procedure or the like (e.g., in the case of instant messaging environments or the like).

The message filter 325 may additionally include any number of mechanisms for performing a message analysis, such as a pure rules-based analysis or a more complex computational analysis. For instance, this particular message filter 325 is also configured to evaluate whether to download or receive an incoming message based on an evaluation of an abbreviated portion 385 of a message, perhaps using the local filter criteria 326. The abbreviated portion may be returned to the messaging client 160 with filtered messages 245 received in response to a request for new messages, or perhaps in response to a request for only the headers of new messages. In one implementation, the abbreviated portion 385 includes at least an identifier 370 for the complete message, and may also include header information for the message such as the subject line text 371, and some part of the body text 372 of the message.

The local filter criteria 326 includes rules that may be applied by the client-side message filter 325 to perform a further content analysis on incoming messages (e.g., filtered messages 245 or abbreviated portion 385). Those rules may include accept/deny decision criteria based on any one or more of multiple characteristics, such as the sender or recipient list of the message, particular words or terms included in the content of the message, and the like.

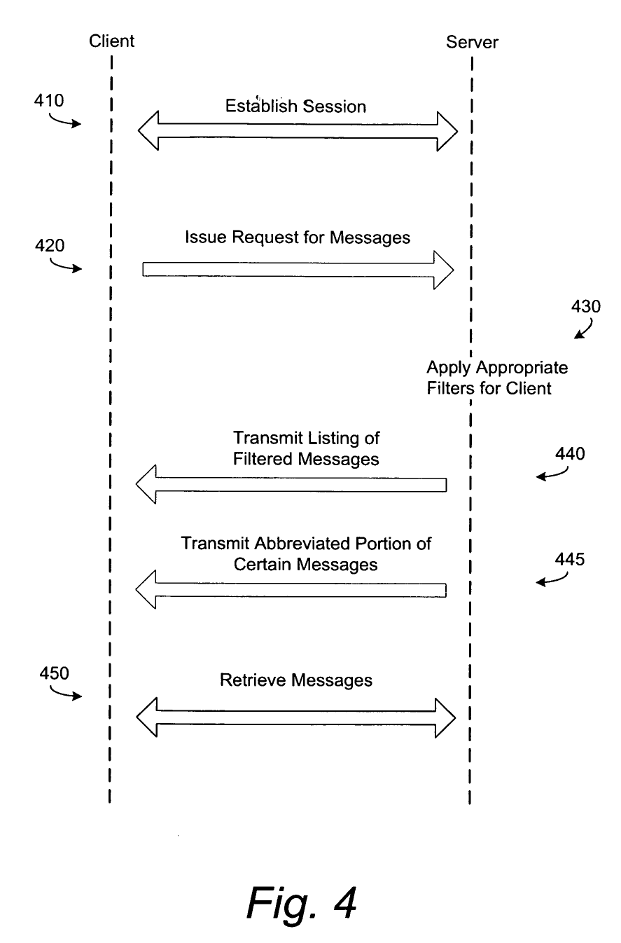

FIG. 4 is an operational flow diagram generally illustrating the flow of messages between a client and a server operating in an electronic message delivery environment. The client may reside on a mobile device, and the server may be a messaging server on a computing device. To begin, at step 410, the client and server initiate a session so that electronic messages may be made available to the client. The session may be an actual negotiated session between the client and the server, or it may be simply the occurrence of a communication from one device to the other, such as an MMS message transmitted to the client.

At step 420, the client issues to the server a request for information about messages stored at the server. The request may be for the actual messages, or it may be for attribute information rather than the messages themselves. Although described here as a request issued by the client, it should be appreciated that the request may be implicit in cases where the server transmits message information to the client asynchronously. In other words, the server may asynchronously transmit notification information to the client without necessarily a request from the client.

A token may be delivered to the server from the client that uniquely identifies the client from other devices that a user may use to retrieve messages. The token may possibly be delivered with the request issued at step 420, or it may possibly be issued during the session negotiation performed at step 410.

At step 430, the server applies any appropriate content-based filters to identify which messages stored at the server to deliver to the client. Those content-based filters may be user-configured, and operate to identify particular messages to deliver to the client, or particular messages that should not be delivered to the client. Some criteria that may be used to identify messages for delivery could include the size of the messages, the existence or absence of attachments, identity or email alias of the sender, priority of the message, the format of the message (e.g., HTML, XML, plain-text, and the like), words or phrases in the messages, words or phrases in headers of the messages, and the like. The content-based filters may also be device specific, and may be applied or not applied based on the token that identifies the requesting client.

At step 440, the server transmits to the client a listing of messages that satisfy whatever content-based filters were applied to the messages. The listing of the filtered messages allows the client to retrieve any messages that satisfy the server-side content-based filters.

In certain situations, the analysis by the server-side content-based filters may not reveal a definitive decision about whether a particular one or more messages should be transmitted to the client. In that case, at step 445 the server may transmit to the client an abbreviated portion of those particular messages for further analysis at the client. In one implementation, the client-side analysis could include client-side filters that are applied to the abbreviated portion of the messages. Alternatively, the abbreviated portion of the messages could be displayed to the user for a final human decision about whether to retrieve the messages.

At step 450, the client retrieves messages from the server. The messages retrieved may include any of the messages determined to satisfy the server-side content-based filters, or any messages noted for further analysis at the client. The messages may be retrieved using any appropriate message transmission protocol.

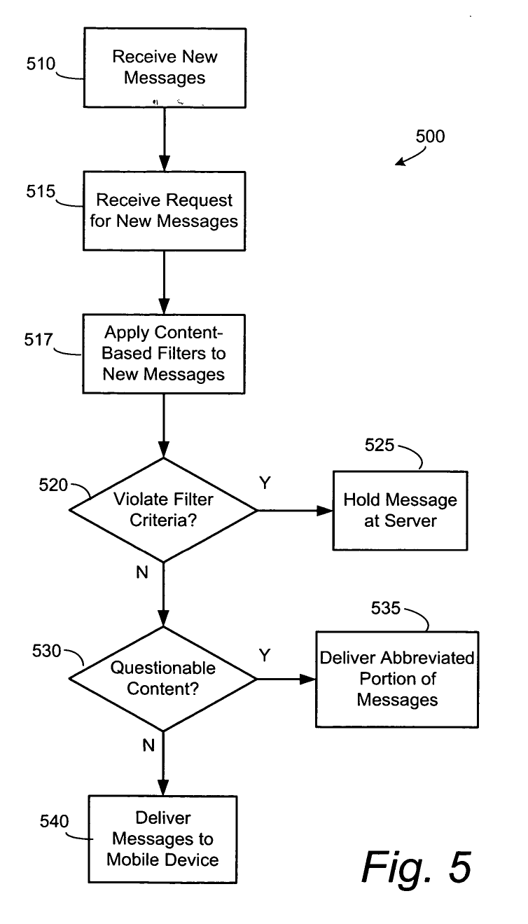

FIG. 5 is a logical flow diagram generally illustrating a process 500 that may be performed at a server according to the implementations described above. The process 500 begins at block 510, where a server receives at least one and possibly several new electronic messages intended for a user of a messaging service provided by the server.

At block 515, the server receives a request for new messages from a messaging client, which resides on a computing device, such as a mobile device, handheld computing device, laptop computing device, desktop computing device, or the like. In one implementation, the request includes a token that distinguishes the client from other clients or devices that the user may employ to check messages. In another implementation, the token may be provided to the server in conjunction with some other communication, such as during an initial session negotiation or perhaps in response to an affirmative request for the token issued by the server to the client.

At block 517, the server applies content-based filters to the new messages to determine which messages are appropriate for download to the mobile device. In one embodiment, the content-based filters implement a rules-based analysis that is performed on each of the new messages. Those content-based filters may be user-configurable, and may include logic that is device-specific. For example, one or more content-based filters may be associated with tokens that uniquely identify devices that a user can use to retrieve messages. Thus, the server may apply any of those content-based filters that are associated with the token received at block 515. The filters may be used to evaluate any particular portion of the new messages, such as the message envelope, headers, subject, sender or recipient list, message body, protocol codes, and the like.

At block 520, if messages violate the filter criteria applied at block 517, those messages are marked to be held at the server (block 525), in a special message store, or the like. One possible way that the messages could be held at the server is to simply exclude those messages from a list of messages that are available for download by the client. Those messages would still be accessible through other mechanisms, such as a Web-based interface or an alternative messaging device.

At block 530, some messages may not clearly violate the filter criteria, such as in the case where a score (e.g., a spam score) is calculated and compared to a threshold rather than a simple pass/fail analysis. In that case, those messages may be identified as having “questionable content” and an abbreviated portion of the messages could be delivered to the client (block 535). The abbreviated portion could include some subset of the body text of the message, the subject of the message, the sender and recipient list, protocol codes, and the like. In addition, the abbreviated portion could be some size-constrained portion of the complete message. In another case, as discussed above, some rules established by the user may be in conflict. In such a case, an abbreviated portion of the message may be sent. Similarly, an hierarchical rule structure may be implemented such that certain rules are prioritized over other rules, thus allowing for conflict resolution.

At block 540, messages that do not have questionable content are delivered to the mobile device. At this point, the server has made available any new messages that do not clearly violate the server-side content based filters, and may possibly have made available information about certain questionable messages. It will be appreciated that this content-based filtering has the advantage of decreasing the number of messages downloaded to the mobile device, perhaps drastically. In addition, the user has the power to configure server-side filter criteria that may be applied in a device-specific manner, thus creating an added degree of control over which messages are delivered to each of the devices that the user could use to retrieve messages.

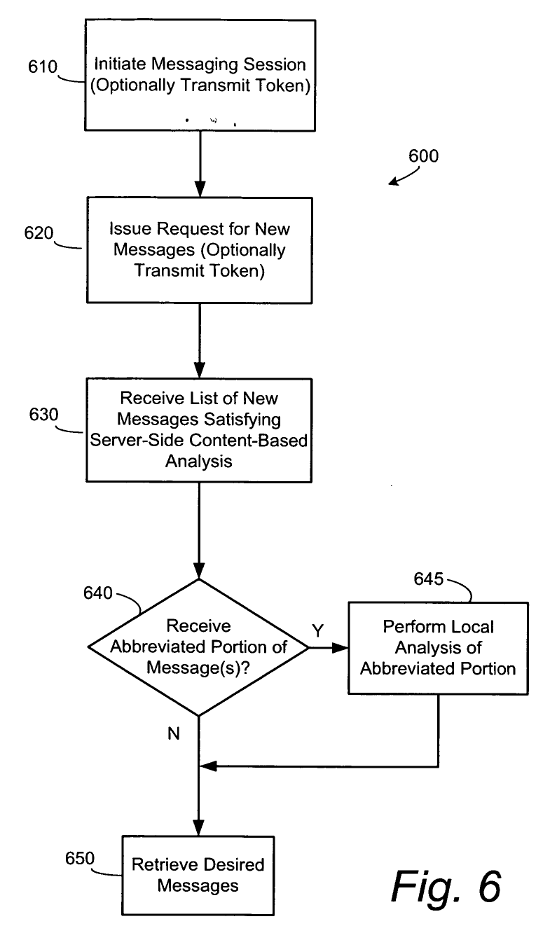

FIG. 6 is a logical flow diagram generally illustrating a process 600 that may be performed at a client according to implementations of the invention. The process 600 may be performed on any computing device capable of retrieving electronic messages, such as a mobile device, handheld computing device, laptop computing device, desktop computing device, and the like.

The process begins at step 610, where the client initiates a messaging session with a server. The server is configured to make new electronic messages available for download to the client. In one implementation, initiating the messaging session (block 610) may include transmitting a token to the server that uniquely identifies the client from other clients.

At block 620, the client issues a request to the server for new messages. In one implementation, the request may be in accordance with an e-mail protocol, such as POP. The token may additionally include the token that uniquely identifies the client. It will be appreciated that if the token was transmitted when the session was initiated, it need not be transmitted with the request. Alternatively, the token may not be delivered at all.

At block 630, the client receives a list of new messages that satisfy server-side content-based filtering. More specifically, the server may include content-based filters that are applied to the new messages to eliminate certain messages that a user may desire not to download to the client. Those content-based filters are user-configurable and may be based on any one or more of many criteria, such as size, text found within the message, particular senders or recipients, and the like. The list received at the client excludes at least any messages at the server that fail those content-based filters.

At step 640, an abbreviated portion of a message may be received in the case that the message includes questionable content. The message includes questionable content, perhaps, if the server-side analysis revealed that the message content does not definitively violate the content-based filters, but may have achieved a score that is in a middle range between a “safe” threshold and a “hold” threshold.

At block 645, if the abbreviated portion has been received, the client performs a local analysis of the abbreviated portion to determine whether to retrieve the complete message. The local analysis could be a further analysis based on the content of the abbreviated portion, such as evaluating the words or terms included in the abbreviated portion. Alternatively, the local analysis could be presenting the abbreviated portion to the user for human evaluation.

At block 650, the client retrieves any desired messages. The desired messages may include any messages on the list received at block 630, and perhaps any messages that survive the local analysis performed at block 645. It should be noted that the client need not necessarily retrieve all the messages identified on the received list. Rather, the client could be configured to retrieve only certain of the messages for other reasons, such as a decision made based on other information transmitted in the list of messages.

FIG. 7 is a functional block diagram generally illustrating the core components of a sample computing device 701 in which implementations of the invention are particularly applicable. The computing device 701 could be any mobile computing device, such as a cellular telephone, a personal digital assistant, a hand-held “palmtop” device, a laptop computer, a portable music player, a global positioning satellite (GPS) device, or the like. Similarly, the computing device 701 could be any fixed computing device, such as a desktop computer or server.

In this example, the computing device 701 includes a processor unit 704, a memory 706, a storage medium 713, and an audio unit 731. The processor unit 704 advantageously includes a microprocessor or a special-purpose processor such as a digital signal processor (DSP), but may in the alternative be any conventional form of processor, controller, microcontroller, or state machine.

The processor unit 704 is coupled to the memory 706, which is advantageously implemented as RAM memory holding software instructions that are executed by the processor unit 704. In this embodiment, the software instructions stored in the memory 706 include an operating system 710 and one or more other applications 712. The memory 706 may be on-board RAM, or the processor unit 704 and the memory 706 could collectively reside in an ASIC. In an alternate embodiment, the memory 706 could be composed of firmware or flash memory.

The processor unit 704 is coupled to the storage medium 713, which may be implemented as any nonvolatile memory, such as ROM memory, flash memory, or a magnetic disk drive, just to name a few. The storage medium 713 could also be implemented as any combination of those or other technologies, such as a magnetic disk drive with cache (RAM) memory, or the like. In this particular embodiment, the storage medium 713 is used to store data during periods when the computing device 701 is powered off or without power.

The computing device 701 also includes a communications module 721 that enables bidirectional communication between the computing device 701 and one or more other computing devices. The communications module 721 may include components to enable RF or other wireless communications, such as a cellular telephone network, Bluetooth connection, wireless local area network, or perhaps a wireless wide area network. Alternatively, the communications module 721 may include components to enable land-line or hard-wired network communications, such as an Ethernet connection, RJ-11 connection, universal serial bus connection, IEEE 7394 (Firewire) connection, or the like. These are intended as non-exhaustive lists and many other alternatives are possible.

The audio unit 731 is a component of the computing device 701 that is configured to convert signals between analog and digital format. The audio unit 731 is used by the computing device 701 to output sound using a speaker 732 and to receive input signals from a microphone 733.

FIG. 7 illustrates only certain components that are generally found in most conventional computing devices. Very many other components are also routinely found in particular implementations, and in certain rare cases, some components shown in FIG. 7 may be omitted. However, the computing device 701 shown in FIG. 7 is typical of the devices commonly found today.

While the invention has been described with reference to particular embodiments and implementations, it should be understood that these are illustrative only, and that the scope of the invention is not limited to these embodiments. Many variations, modifications, additions and improvements to the embodiments described above are possible. It is contemplated that these variations, modifications, additions and improvements fall within the scope of the invention as detailed within the following claims.

The preceding description of the preferred embodiments is provided to enable any person skilled in the art to make or use the present invention. The various modifications to these embodiments will be readily apparent to those skilled in the art, and the generic principles presented may be applied to other embodiments without the use of the inventive faculty. Thus, the present invention is not intended to be limited to the embodiments shown but is to be accorded the widest scope consistent with the principles and novel features disclosed herein.

I claim:

1. A computer-implemented method for electronic messaging, comprising:
receiving an electronic message;
receiving a request for messages;
applying a content-based filter on the electronic message, the content-based filter being configurable to determine if the electronic message should be transmitted; and
if the electronic message does not fail the content-based filter, making the electronic message available for retrieval by a client.

2. The computer-implemented method recited in claim 1, further comprising if the content-based filter indicates that the electronic message includes questionable content, delivering an abbreviated portion of the electronic message for further analysis.

3. The computer-implemented method recited in claim 2, wherein the abbreviated portion includes content from a body portion of the electronic message.

4. The computer-implemented method recited in claim 2, wherein the abbreviated portion is a size-based portion of the electronic message.

5. The computer-implemented method recited in claim 1, further comprising receiving at the server a token that distinguishes the client from other clients; and wherein applying the content-based filter further comprises evaluating logic in the content-based filter to determine whether to apply the content-based filter based on the token.

6. The computer-implemented method recited in claim 1, wherein the content-based filter comprises logic to evaluate the electronic message against filter criteria that identifies characteristics of electronic messages that have been deemed undesirable for download.

7. The computer-implemented method recited in claim 1, wherein the content-based filter is one filter in a plurality of hierarchically prioritized filters, and wherein conflict between two or more filters in the plurality is resolved using the respective priorities of the filters in conflict.

8. A computer-implemented method for electronic messaging, comprising:
issuing a request for new messages;
receiving a list of messages that are stored at a server and that satisfy a server-side content-based filter, the list of messages excluding messages at the server that fail the server-side content-based filter; and
retrieving at least one of the messages on the list of messages.

9. The computer-implemented method of claim 8, further comprising receiving an abbreviated portion of a questionable message and performing a client-side analysis on the abbreviated portion to determine whether to retrieve the questionable message.

10. The computer-implemented method recited in claim 9, wherein the abbreviated portion includes content from a body portion of the questionable message.

11. The computer-implemented method recited in claim 9, wherein the abbreviated portion is a size-based portion of the electronic message.

12. The computer-implemented method recited in claim 8, further comprising issuing a token that distinguishes a client from other clients; and wherein the list of messages further excludes at least one message using logic at the server based on the token.

13. The computer-implemented method recited in claim 12, wherein the token comprises a code that distinguishes the client from other clients that are also configured to retrieve the new messages from the server.

14. A server for delivering electronic messages, comprising:
a communication module operative to support a communication session between the server and a client that requests to retrieve messages;
a storage medium on which is stored at least one electronic message;
a processor; and
a memory coupled to the processor and the storage medium, and in which resides computer-executable components of a messaging system, the components comprising:
a message server configured to perform message delivery services;
filter criteria that identifies characteristics of electronic messages that have been deemed undesirable for download to the client; and
a message filter operative to evaluate the at least one electronic message stored on the storage medium against the filter criteria to identify if the electronic message fails the filter criteria.

15. The server recited in claim 14, wherein the filter criteria includes logic to determine whether to apply the filter criteria based on a token that distinguishes the client from other clients that are also configured to retrieve the messages from the server.

16. The server recited in claim 14, wherein the message filter is further configured to extract an abbreviated portion of a questionable message, based on the evaluation, and to make the abbreviated portion of the questionable message available to the client for further analysis.

17. The server recited in claim 16, wherein the abbreviated portion includes content from a body portion of the electronic message.

18. The server recited in claim 16, wherein the abbreviated portion is a size-based portion of the electronic message.

19. The server recited in claim 14, wherein the filter criteria comprises a plurality of hierarchically prioritized content filters, and wherein conflict between two or more content filters in the plurality is resolved using the respective priorities of the content filters in conflict.

20. A client for retrieving electronic messages, comprising:
a communication module operative to support a communication session between the client and a server on which are stored electronic messages;
a storage medium;
a processor; and
a memory coupled to the processor and the storage medium, and in which resides computer-executable components of a messaging client, the components comprising:
a token including a unique identifier;
filter criteria; and
a message filter operative to evaluate an abbreviated portion of an electronic message transmitted to the client from the server, the evaluation being performed using the filter criteria.

21. The client recited in claim 20, wherein the messaging client is configured to transmit the token to the server for use in determining whether to apply at least one server-side filter on messages at the server.

22. A computer-readable medium having computer-executable instructions for electronic messaging by a server, the instructions comprising:
receiving an electronic message;
receiving a request for messages;
applying a content-based filter on the electronic message, the content-based filter being configurable to determine if the electronic message should be transmitted; and
if the electronic message does not fail the content-based filter, making the electronic message available for retrieval by a client.

23. The computer-readable medium recited in claim 22, further comprising if the content-based filter indicates that the electronic message includes questionable content, delivering an abbreviated portion of the electronic message for further analysis.

24. The computer-readable medium recited in claim 23, wherein the abbreviated portion includes content from a body portion of the electronic message.

25. The computer-readable medium recited in claim 23, wherein the abbreviated portion is a size-based portion of the electronic message.

26. The computer-readable medium recited in claim 22, further comprising receiving a token that distinguishes the client from other clients; and wherein applying the content-based filter further comprises evaluating logic in the content-based filter to determine whether to apply the content-based filter based on the token.

27. The computer-readable medium recited in claim 22, wherein the content-based filter comprises logic to evaluate the electronic message against filter criteria that identifies characteristics of electronic messages that have been deemed undesirable for download.

28. The computer-readable medium recited in claim 22, wherein the content-based filter is one filter in a plurality of hierarchically prioritized filters, and wherein conflict between two or more filters in the plurality is resolved using the respective priorities of the filters in conflict.

29. A computer-readable medium having computer-executable instructions for electronic messaging by a client, the instructions comprising:
issuing a request for new messages;
receiving a list of messages stored at a server that satisfy a server-side content-based filter, the list of messages excluding messages that fail the server-side content-based filter; and
retrieving at least one of the messages on the list of messages.

30. The computer-readable medium recited in claim 29, further comprising receiving an abbreviated portion of a questionable message and performing a client-side analysis on the abbreviated portion to determine whether to retrieve the questionable message.

31. The computer-readable medium recited in claim 30, wherein the abbreviated portion includes content from a body portion of the questionable message.

32. The computer-readable medium recited in claim 30, wherein the abbreviated portion is a size-based portion of the electronic message.

33. The computer-readable medium recited in claim 29, further comprising issuing to the server a token that distinguishes the client from other clients; and wherein the list of messages further excludes at least one message using logic at the server based on the token.

34. The computer-readable medium recited in claim 33, wherein the token comprises a code that is provided to the client that distinguishes the client from other clients that are also configured to retrieve the new messages from the server

35. A computer-implemented method for electronic messaging, comprising:
means for receiving an electronic message;
means for receiving a request for messages;
means for applying a content-based filter on the electronic message, the content-based filter being configurable to determine if the electronic message should be transmitted; and
if the electronic message does not fail the content-based filter, means for making the electronic message available for retrieval by a client

36. A computer-implemented method for electronic messaging, comprising:
means for issuing a request for new messages;
means for receiving a list of messages at a server that satisfy a server-side content-based filter, the list of messages excluding messages at the server that fail the server-side content-based filter; and
means for retrieving at least one of the messages on the list of messages.
